(19) United States
(12) Patent Application Publication
(10) Pub. No.: US 2006/0185525 A1
(43) Pub. Date: Aug. 24, 2006

(54) Method for the treatment of food products, as well as continuous oven therefor

(75) Inventor: Hendrikus Antonius Jacobus Kuenen, Overloon (NL)

Correspondence Address: THE WEBB LAW FIRM, P.C., 700 KOPPERS BUILDING, 436 SEVENTH AVENUE, PITTSBURGH, PA, 15219, US

(73) Assignee: CFS BAKEL B.V., Bakel (NL)

(21) Appl. No.: 11/351,900

(22) Filed: Feb. 10, 2006

(30) Foreign Application Priority Data
Feb. 11, 2005 (NL) 1028252

(51) Int. Cl. A23C 3/00

(52) U.S. Cl. 99/386; 426/523

(57) ABSTRACT

A continuous oven has an elongated housing, an endless conveyor belt that extends in the longitudinal direction through the housing and on which food products can be conveyed over a stretch between an input and an output of the oven, a hot air heater, as well as a hot air flow guide for making hot air flow in the longitudinal direction along the conveyor belt over part of said stretch. The hot air flow guide is also arranged for making hot air flow transversely to and directed towards a surface of the conveyor belt.

The invention relates to a method for the treatment of food products in a continuous oven, comprising the following steps:

feeding the products through the continuous oven on a conveyor belt permeable to air along a stretch between input and the output of the continuous oven,

creating a hot air flow over part of said stretch in the longitudinal direction of the conveyor belt.

Such a method for heating food products is disclosed in EP-A 312 335. In the case of this known method the hot air is fed transversely over the conveyor belt from the two longitudinal sides of the continuous oven. The hot air subsequently flows in the longitudinal direction of the conveyor belt via a return point back to a fan. The disadvantage of this known continuous oven is that the air flow is not very suitable for producing browning of the outside of the food products. However, the provision of a crisp brown crust is very desirable for certain food products. It makes these product more attractive to the consumer, who consequently experiences a better taste.

The aim of the invention is therefore to provide a method for operating a continuous oven of the abovementioned type wherein it is also possible to brown the outside of the food products. Said aim is achieved by also creating a hot air flow transversely to and directed towards a surface of the conveyor belt.

Reference is made to the continuous oven disclosed in EP-A 316 373. In the case of this known continuous oven a number of ducts are disposed transversely above the conveyor belt. The ducts each have a number of jet openings directed towards the top and bottom surface, respectively, of the conveyor belt in order to deliver jets of hot air. As a result, the food products on the conveyor belt are treated only by these jets of hot air directed perpendicularly to the conveyor belt. The disadvantage of this is that such an intensive treatment cannot be moderated by also exposing the products to a less powerful air flow which can, for example, blow across or along the belt. This means that the known oven is less flexible in its uses and is suitable only for products which are well able to withstand such an intensive treatment.

This known treatment method is therefore less suitable for fragile food products. On account of the fact that in the case of the continuous oven according to the invention the food products can be subjected to a mixed treatment, that is to say both to powerful jets of hot air and to a more moderate hot air flow, this continuous oven is suitable for a variety of products and a variety of methods for treatment thereof.

In this respect it is preferable to provide for the hot air flow to be created transversely to and directed towards a surface of the conveyor belt over a part of said stretch which is different from the part of the stretch over which the hot air flow is directed in the longitudinal direction of the conveyor belt. The different parts of the stretch can be adjusted in relation to each other in such a way, for example with regard to their mutual length, that the desired treatment can be ensured.

The hot air is preferably allowed to flow from the one stretch to the other stretch; in particular, the hot air can be circulated past a heating device, a hot air flow can then be created transversely to and directed towards surface of the conveyor belt and thereafter a hot air flow can also be created in the longitudinal direction of the conveyor belt. Furthermore, hot air can also be fed onto the products both from above and from below.

According to a preferred embodiment the method according to the invention comprises running the conveyor belt through several contiguous, separate stretches, which stretches each have a part over which a hot air flow is created transversely to and directed towards a surface of the conveyor belt, for subjecting the products to a first heat treatment, and another part over which a hot air flow is created in the longitudinal direction of the conveyor belt, for subjecting the products to a second heat treatment.

The invention further relates to a continuous oven for carrying out the method described above. This continuous oven comprises an elongated housing, an endless conveyor belt that extends in the longitudinal direction through the housing and on which food products can be conveyed over a stretch between an input and an output of the oven, hot air heating means, as well as hot air flow guide means for making hot air flow in the longitudinal direction along the conveyor belt over part of said stretch. Such a continuous oven is also disclosed in EP-A 312 335. According to the invention provision is made for the hot air flow guide means also to be arranged for making hot air flow in the transverse direction to and directed towards a surface of the conveyor belt. This preferably takes place over a different part of said stretch.

In order to obtain the desired degree of browning of the food products, the hot air flow guide means comprise jet means for delivering jets of hot air in the direction of, and essentially perpendicular to, a surface of the conveyor belt. Said jet means can extend above and/or below the belt.

For the purpose of regulated circulation of the hot air, a divider can extend above the conveyor belt. A heat source for heating the air is preferably situated above this divider, while return openings are situated at both ends of said divider for making the air circulate past the heat source and in the longitudinal direction along the conveyor belt. For making the air circulate, a fan is provided, preferably at the location of one of the return openings.

The divider can be extended as far as one of the longitudinal ends of the housing in such a way that the fan is connected to a return opening in the divider near said longitudinal end.

The conveyor belt is accommodated in an air jet chamber over at least part of its length. Said air jet chamber is bounded by at least one longitudinal boundary that extends along the conveyor belt; the longitudinal boundary is provided with passages for generating jets of air.

The longitudinal boundary preferably comprises boundary plates that extend above and below the conveyor belt and are each provided with passages. Furthermore, the longitudinal boundary can also have boundary plates extending alongside the conveyor belt on either side. In particular, a passage for hot air can be situated on either side of the longitudinal boundary, which passages extend essentially in the vertical direction.

The invention will be explained in more detail below with reference to an illustrative embodiment shown in the figures.

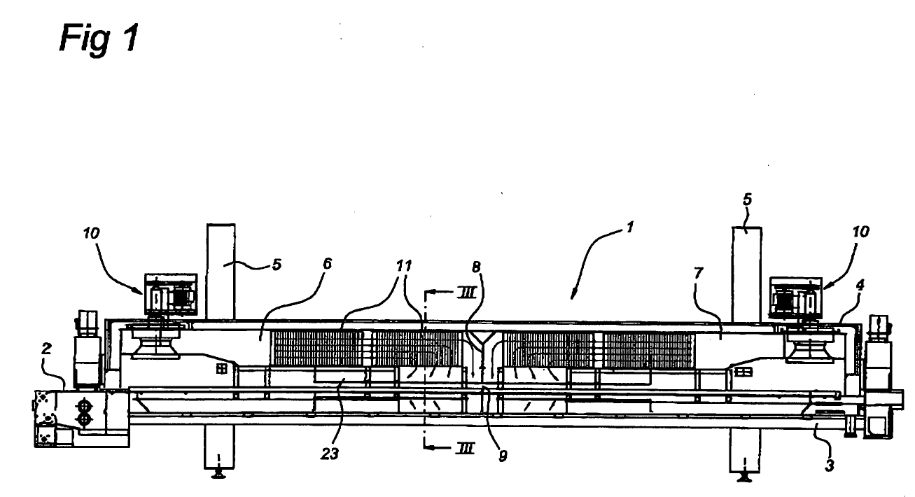

FIG. 1 shows an exposed side view of the continuous oven according to the invention.

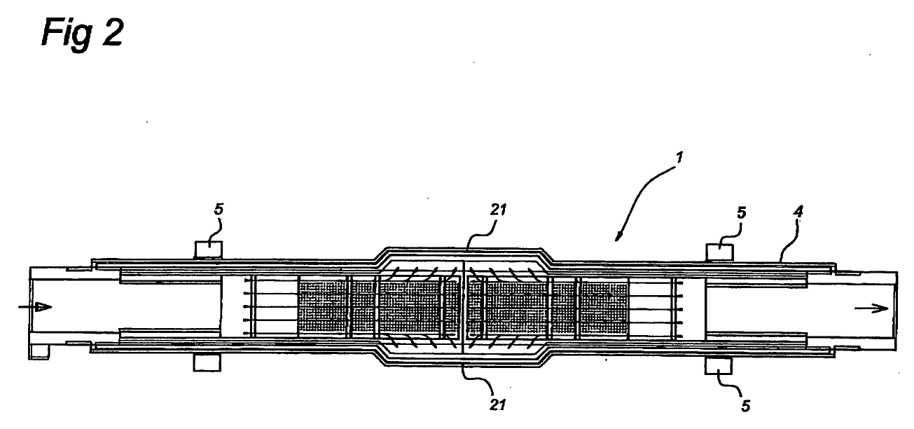

FIG. 2 shows a plan view.

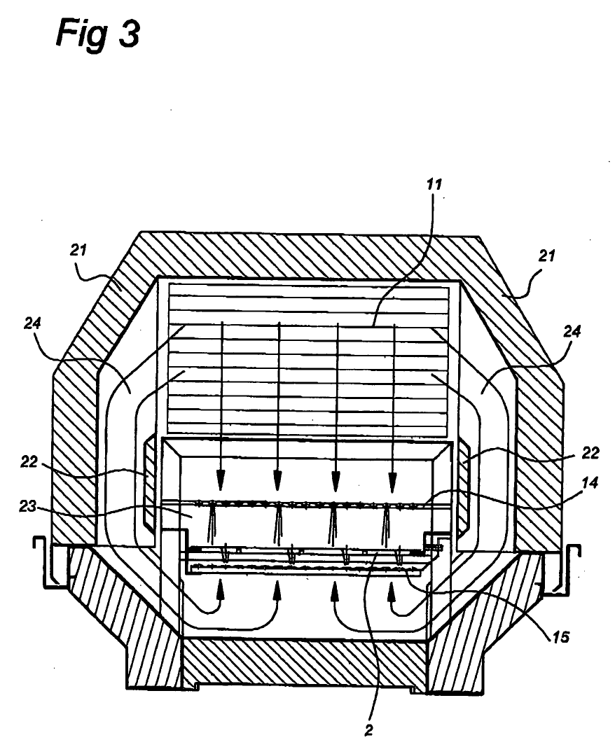

FIG. 3 shows a cross-section along III-III in FIG. 1.

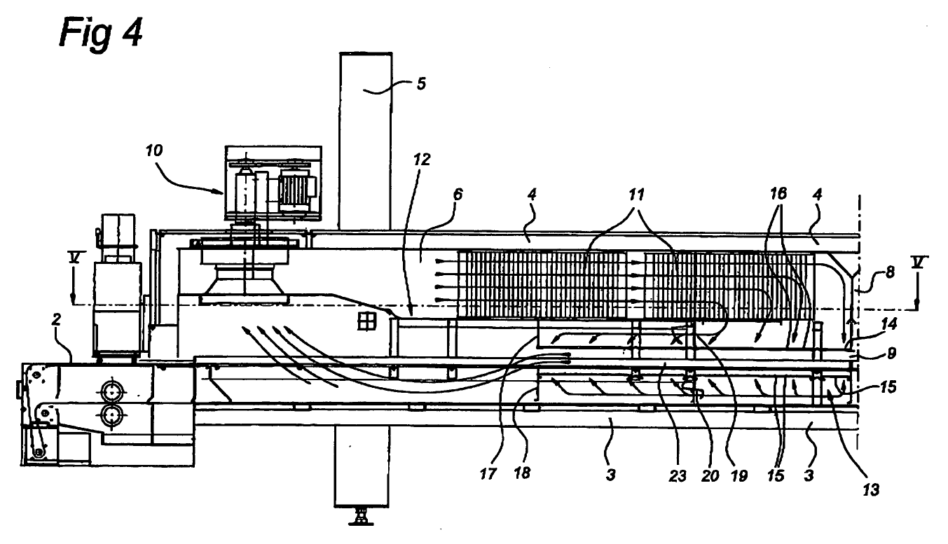

FIG. 4 shows an enlarged section through a part of the continuous oven.

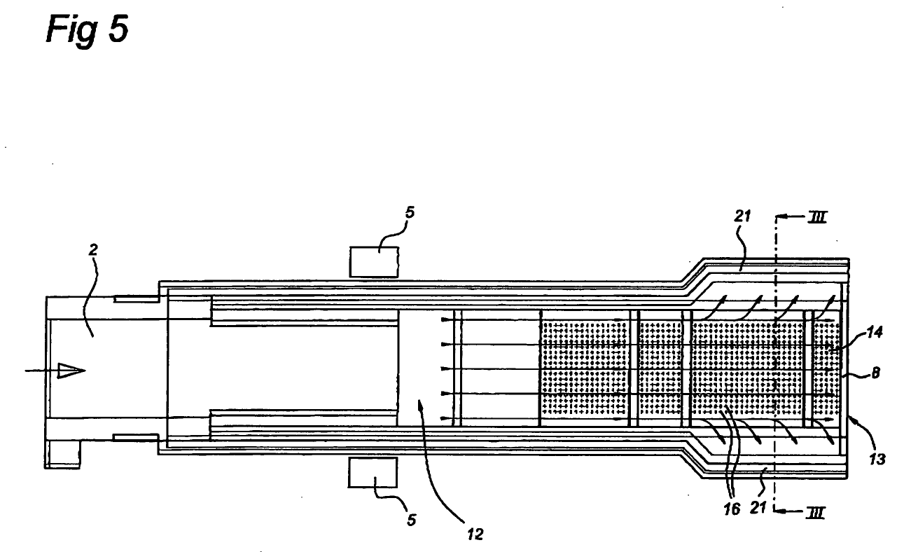

FIG. 5 shows a section along V-V in FIG. 4.

The continuous oven shown in FIGS. 1-5 for carrying out the method according to the invention comprises an elongated housing, indicated in its entirety by 1, through which an endless conveyor belt 2 is run. The housing 1 comprises a tray 3, relative to which the cap 4 can be moved up and down. For this purpose, the cap 4 is suspended by means of lifting means which are known per se.

The interior of the oven is divided into two chambers 6, 7, which are separated by the partition wall 8. The conveyor belt 2 is run through the partition wall 8 via the opening 9 in the partition wall 8.

Each chamber 6, 7 has a fan 10 as well as heating means 11, as will be explained in more detail with references to FIGS. 4 and 5. This fan 10 and heating means 11 are situated on the top of the dividing wall indicated in its entirety by 12 and running essentially in the longitudinal direction through the chamber 6. Air is sucked out of the chamber below the dividing wall 12 by the fan 10 and is forced past the heating means 11. At the end of the dividing wall 12 the air heated in this way is moved downwards to where the conveyor belt 2 with the products thereon is situated. The air then flows back into the chamber below the dividing wall 12.

According to the invention, the hot air flow guide means, indicated in their entirety by 13, are provided in this region, by means of which hot air flow guide means the hot air is forced transversely to and against the surface of the conveyor belt 2. The effect of this flow is that the products on the conveyor belt 2 are subjected to relatively powerful jets, which result in an increased browning effect. The hot air flow guide means therefore comprise two plates 14, 15 in which a large number of jet holes or jet pipes 16 are situated. An end panel 17, 18 is provided at the downstream end of each of the plates 14, 15. The upper end panel 17 extends between the upper plate 14 and the dividing wall 12; the lower end panel 18 extends from the lower plate 15 to just above the base of the tray 3. The conveyor belt makes the return run between the bottom edge of the end panel 18 and the base of the tray 3.

According to a first possibility, the hot air coming from the heating means 11 can be directed perpendicularly to the belt surface over the entire length of the plates 14, 15. According to another possibility, said air flow can remain concentrated in the region that is situated between the end of the dividing wall 12 and the partition wall 8. That is achieved by the flaps 19, 20, which can be moved from a raised position (shown by broken lines) to an active position extending transversely to the plates 14, 15, as shown by solid lines.

In connection with the feed of hot air to the lower plate 15, at the location of the region between the end of the dividing wall 12 and the partition wall 8 the cap 4 is widened by the expanded sections 21. Since the dividing wall 12 is slidable, this region can be enlarged or reduced. This means that the flow volume can be distributed as desired over the top and the bottom of the conveyor belt 2. The cross-section of FIG. 3 is taken at the location of these expanded sections 21. As can be seen in this cross-section, longitudinal boundaries 22 extend in this region on either side of the conveyor belt 2, which longitudinal boundaries should ensure that the hot air does not flow transversely over the belt, but is fed directed vertically upwards from below.

1.-32. (canceled)

33. A method for the treatment of food products in a continuous oven, comprising the steps of:
a) feeding the products through the continuous oven on a conveyor belt permeable to air along a stretch between the input and the output of the continuous oven, and
b) generating a hot air flow over part of said stretch in the longitudinal direction of the conveyor belt, wherein a hot air flow is generated transversely to and directed towards a surface of the conveyor belt.

34. The method according to claim 33, wherein at least one hot air flow is generated over another part of said stretch transversely to a surface of the conveyor belt.

35. The method according to claim 33, wherein the hot air flow is directed from the one part of the stretch to the other part of the stretch.

36. The method according to claim 34, wherein the hot air is circulated past a heating device, subsequently generating a hot air flow transversely to and directed towards a surface of the conveyor belt.

37. The method according to claim 33, wherein hot air is fed to the products both from above and from below.

38. The method according to claim 33, wherein the conveyor belt is run through several contiguous, separate stretches, which stretches each have a part over which a hot air flow is generated transversely to and directed towards a surface of the conveyor belt, for subjecting the products to a first heat treatment, and another part over which a hot air flow is generated in the longitudinal direction of the conveyor belt, for subjecting the products to a second heat treatment.

39. A continuous oven for the treatment of food products, comprising an elongated housing, an endless conveyor belt that extends in a longitudinal direction through the housing and on which food products can be conveyed over a stretch between an input and an output of the oven, hot air heating means, and hot air flow guide means for making hot air flow in the longitudinal direction along the conveyor belt over part of said stretch, wherein the hot air flow guide means are also arranged for making hot air flow transversely to and directed towards a surface of the conveyor belt.

40. The continuous oven according to claim 39, wherein the hot air flow guide means are arranged for making hot air flow in the transverse direction to a surface of the conveyor belt over another part of said stretch.

41. The continuous oven according to claim 40, wherein the hot air flow guide means comprise jet means for delivering jets of hot air in the direction of, and essentially perpendicularly to, a surface of the conveyor belt.

42. The continuous oven according to claim 41, wherein the jet means extend above the conveyor belt.

43. The continuous oven according to claim 40, wherein the jet means extend below the conveyor belt.

44. The continuous oven according to claim 40, wherein a divider extends above the conveyor belt, above which divider a heat source for heating the air is situated, return openings being situated at both ends of said divider for making the air circulate past the heat source and in the longitudinal direction along the conveyor belt.

45. The continuous oven according to claim 44, wherein a fan is provided for circulation of the air.

46. The continuous oven according to claim 45, wherein the fan is situated at the location of one of the return openings.

47. The continuous oven according to claim 46, wherein the divider is extended as far as one of the longitudinal ends of the housing and the fan is connected to a return opening in the divider near said longitudinal end.

48. The continuous oven according to claim 39, wherein the conveyor belt is accommodated in an air jet chamber over at least part of its length.

49. The continuous oven according to claim 48, wherein the air jet chamber is bounded by at least one longitudinal boundary that extends along the conveyor belt.

50. The continuous oven according to claim 49, wherein the longitudinal boundary is provided with passages for generating jets of air.

51. The continuous oven according to claim 49, wherein the longitudinal boundary is connected to the divider.

52. The continuous oven according to claim 51, wherein the longitudinal boundary comprises boundary plates that extend above and below the conveyor belt and are each provided with passages.

53. The continuous oven according to claim 52, wherein the longitudinal boundary has boundary plates extending alongside the conveyor belt on either side.

54. The continuous oven according to claim 52, wherein a passage for hot air is situated on either side of the longitudinal boundary, which passages extend essentially in the vertical direction.

55. The continuous oven according to claim 52, wherein the divider comprises a divider plate extending above the upper boundary plate, which divider plate and upper boundary plate are connected to one another by means of a transverse panel.

56. The continuous oven according to claim 55, wherein the divider plates and the upper boundary plate partially overlap.

57. The continuous oven according to claim 56, wherein the upper boundary plate projects in the longitudinal direction relative to the divider plate and the transverse panel is situated at the end of the upper boundary plate which overlaps the divider plate.

58. The continuous oven according to claim 57, wherein the part of the air jet chamber that is delimited by the divider plate, the upper boundary plate and the transverse panel can be shut off by means of a flap.

59. The continuous oven according to claim 55, wherein the divider plate has a variable length for varying the size of the return opening situated opposite the fan.

60. The continuous oven according to claim 52, wherein the lower boundary plate is connected to a transverse panel which extends to the base of the housing.

61. The continuous oven according to claim 60, wherein the transverse panel extends to the base, leaving a free passage for the return part of the conveyor belt.

62. The continuous oven according to claim 60, wherein the lower boundary plate projects in the longitudinal direction relative to the divider plate and the transverse panel is situated at the end of the lower boundary plate which overlaps the divider plate.

63. The continuous oven according to claim 62, wherein the part of the air jet chamber that is delimited by the divider plate, the lower boundary plate and the transverse panel can be shut off by means of a flap.

64. The continuous oven according to claim 39, wherein the housing comprises two chambers which are separated by a partition, in which partition there is a passage through which the conveyor belt is run, in each of which chambers respective hot air heating means and hot air guide means are provided for setting various processing conditions.

65. The method according to claim 36, further including the subsequent step of generating a hot air flow in the longitudinal direction of the conveyor belt.
